(19) United States
(12) Patent Application Publication
(10) Pub. No.: US 2024/0232977 A1
(43) Pub. Date: Jul. 11, 2024

(54) COMPUTERIZED SYSTEMS AND METHODS FOR OPTIMIZING PRODUCT RECOMMENDATIONS USING MACHINE LEARNING AND HASHING ALGORITHMS

(71) Applicant: COUPANG CORP., Seoul (KR)

(72) Inventors: Chen PENG, Sunnyvale, CA (US); Xinli BAO, Palo Alto, CA (US)

(73) Assignee: COUPANG CORP., Seoul (KR)

(21) Appl. No.: 18/148,960

(22) Filed: Dec. 30, 2022

(51) Int. Cl. G06Q 30/0601; G06Q 30/0204; G06Q 30/0251

(52) U.S. Cl. CPC G06Q 30/0631; G06Q 30/0204; G06Q 30/0255

(57) ABSTRACT

Computer-implemented systems and methods for optimizing product recommendations are disclosed and may be configured to receive a request to generate a list of one or more product identifiers mapped to one or more candidate customer identifiers, generate a seed customer identifier list based on retrieved seed data, input the seed customer identifier list and retrieved attribute data into a first engine including a machine learning model, generate a plurality of values to select one or more attributes of the attribute data, generate a plurality of feature vectors, calculate a similarity score for a set of the plurality of feature vector pairs, generate a set of customer identifier pairs, and generate the list of one or more product identifiers mapped to one or more candidate customer identifiers based on the generated set of customer identifier pairs, the seed customer identifier list, and one or more predetermined rules.

### TECHNICAL FIELD

The present disclosure generally relates to computerized systems and methods for optimizing product recommendations. In particular, embodiments of the present disclosure relate to inventive and unconventional systems for optimizing product recommendations by using machine learning and hashing algorithms to efficiently and accurately identify customers who are most similar to customers who have previously purchased a product, and are therefore likely to make a similar purchase.

### BACKGROUND

In online marketing, a problem that is often challenging to solve is figuring out the right audience to target in order to maximize sales of select products. For example, select products may include food products that are close to expiring, clothing items that are soon to be out of season, or other inventory that has failed to be sold for an extended period of time that may need to be discarded. Such select products may require companies to provide an extra push to encourage customers to make a purchase within a short period of time.

To mitigate such problems, conventional systems implement preventative actions to encourage the selling of products. For example, preventative actions may include advertising a discount associated with an item, updating a website to reduce a price associated with an item, updating an order quantity of an item, etc. While these systems attempt to quickly sell products and minimize loss, they are not the most effective or financially optimal because they are not directly targeting an audience that is likely to be interested and are simply preventative measures to avoid a complete monetary loss.

In order to improve upon such measures, some conventional systems implement a recommendation engine to recommend certain products to customers based on the customers' historical actions. For example, based on a customer looking at a dress, the system may recommend a similar dress by identifying similarities between the dresses. However, while such systems attempt to recommend products to customers by identifying products similar to ones of interest to the customers, they are not configured to consider the unique attributes of millions of customers, and thus lack the quality and speed necessary to find the right audience to target to maximize sales of select products.

Therefore, there is a need for improved methods and systems for optimizing product recommendations by implementing machine learning and hashing algorithms to efficiently and accurately identify similarities between customers.

### SUMMARY

One aspect of the present disclosure is directed to a system comprising one or more memory devices storing instructions and one or more processors configured to execute the instructions to perform a method for optimizing product recommendations. The method includes receiving a request to generate a list of one or more product identifiers mapped to one or more candidate customer identifiers, retrieving seed data associated with the one or more product identifiers, generating a seed customer identifier list based on the retrieved seed data, retrieving attribute data associated with a plurality of candidate customer identifiers, and inputting the seed customer identifier list and attribute data into a first engine, wherein the first engine includes a machine learning model. The method further includes generating, from the machine learning model, a plurality of values, wherein each value corresponds to an attribute of the attribute data, selecting, based on the generated plurality of values, one or more attributes of the attribute data, generating a plurality of feature vectors based on the selected one or more attributes, calculating at least one similarity score for a set of the plurality of feature vector pairs, wherein each feature vector pair includes a candidate feature vector associated with the plurality of candidate customer identifiers and a seed feature vector associated with the seed customer identifier list, generating a set of customer identifier pairs based on the at least one similarity score, and generating the list of one or more product identifiers mapped to one or more candidate customer identifiers based on the generated set of customer identifier pairs, the seed customer identifier list, and one or more predetermined rules.

Another aspect of the present disclosure is directed to a method for optimizing product recommendations. The method includes receiving a request to generate a list of one or more product identifiers mapped to one or more candidate customer identifiers, retrieving seed data associated with the one or more product identifiers, generating a seed customer identifier list based on the retrieved seed data, retrieving attribute data associated with a plurality of candidate customer identifiers, and inputting the seed customer identifier list and attribute data into a first engine, wherein the first engine includes a machine learning model. The method further includes generating, from the machine learning model, a plurality of values, wherein each value corresponds to an attribute of the attribute data, selecting, based on the generated plurality of values, one or more attributes of the attribute data, generating a plurality of feature vectors based on the selected one or more attributes, calculating at least one similarity score a set of the plurality of feature vector pairs, wherein each feature vector pair includes a candidate feature vector associated with the plurality of candidate customer identifiers and a seed feature vector associated with the seed customer identifier list, generating a set of customer identifier pairs based on the at least one similarity score, and generating the list of one or more product identifiers mapped to one or more candidate customer identifiers based on the generated set of customer identifier pairs, the seed customer identifier list, and one or more predetermined rules.

Yet another aspect of the present disclosure is directed to a system comprising one or more memory devices storing instructions and one or more processors configured to execute the instructions to perform a method for optimizing product recommendations. The method includes receiving, from a user device, a request to generate a list of a plurality of product identifiers mapped to a plurality of potential customer identifiers, inputting a seed customer identifier list and attribute data into a first engine, wherein the first engine includes a machine learning algorithm, generating, using the machine learning algorithm, a plurality of values to select a plurality of attributes of the attribute data, generating a plurality of feature vectors based on the generated plurality of values, and calculating a plurality of similarity scores, wherein each similarity score corresponds to a feature vector pair of a plurality of feature vector pairs, and wherein each feature vector pair includes a potential feature vector and a seed feature vector. The method further includes generating the list of the plurality of product identifiers mapped to the plurality of potential customer identifiers based on the calculated plurality of similarity scores, the seed customer identifier list, and one or more predetermined rules, transmitting the generated list of the plurality of product identifiers mapped to the plurality of potential customer identifiers to the user device, and causing a customer interface of a customer device associated with a potential customer identifier of the generated list of the plurality of product identifiers mapped to the plurality of potential customer identifiers to display information associated with at least one product identifier of the plurality of product identifiers.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 shows an exemplary method for optimizing product recommendations, consistent with the disclosed embodiments.

FIG. 4 shows a diagram illustrating an exemplary process performed by a machine learning algorithm, consistent with the disclosed embodiments.

FIG. 5 shows a table illustrating an exemplary output of a system for optimizing product recommendations, consistent with the disclosed embodiments.

FIG. 6 shows a table illustrating an exemplary output of a system for optimizing product recommendations, consistent with the disclosed embodiments.

FIG. 7 shows a diagram illustrating an exemplary flow of optimizing product recommendations, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for optimizing product recommendations by inputting a seed customer identifier list and attribute data into a first engine, wherein the first engine includes a machine learning algorithm, generating, using the machine learning algorithm, a plurality of values to select a plurality of attributes of the attribute data, generating a plurality of feature vectors based on the generated plurality of values, and calculating a plurality of similarity scores, wherein each similarity score corresponds to a feature vector pair of a plurality of feature vector pairs, and wherein each feature vector pair includes a potential feature vector and a seed feature vector. The method further includes generating a list of the plurality of product identifiers mapped to the plurality of potential customer identifiers based on the calculated plurality of similarity scores, the seed customer identifier list, and one or more predetermined rules. The disclosed embodiments provide innovative technical features to accurately target customers in an efficient manner. For example, the disclosed embodiments enable for calculation of impurity values using a machine learning algorithm, enable identification of a select set of attributes of attribute data based on the calculated impurity values, enable generation of feature vectors to identify approximate nearest neighbors using a locality hashing algorithm, and enable determination of one or more optimal customers to target for each product.

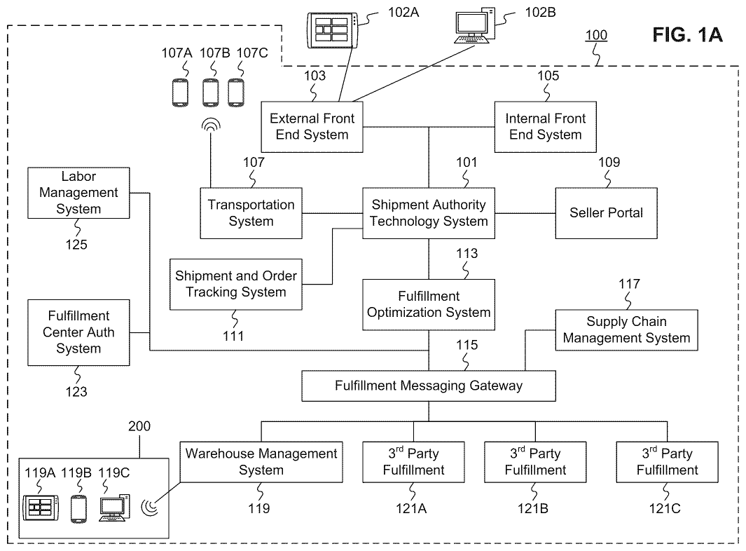

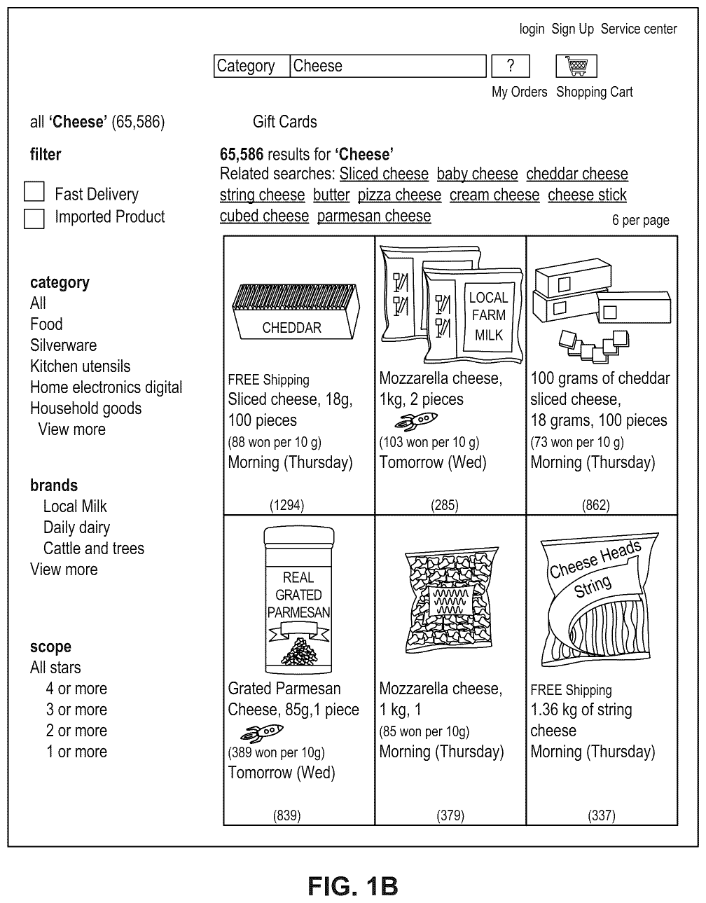

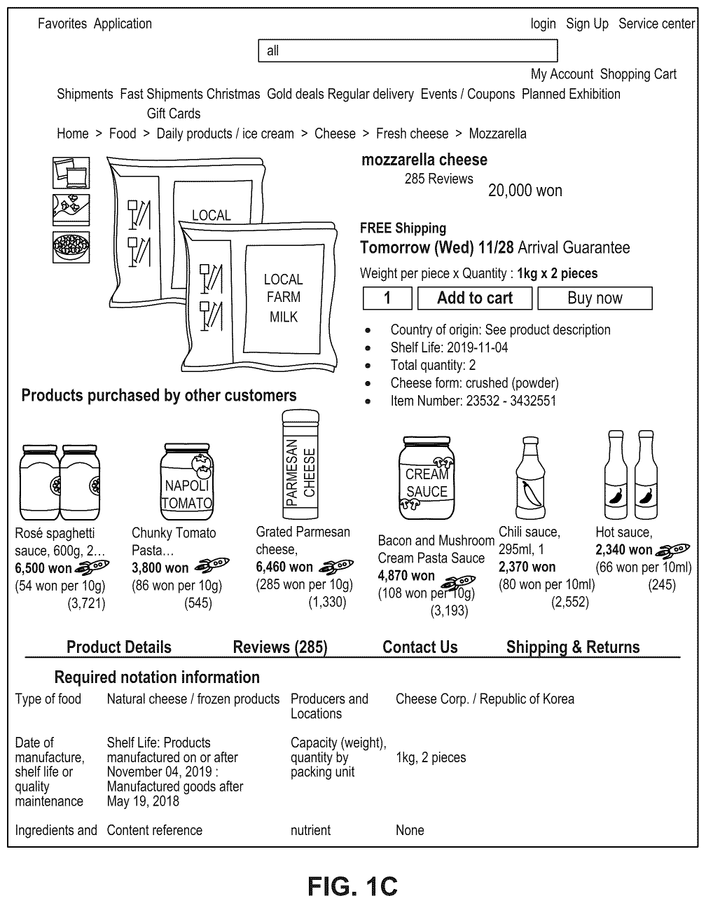

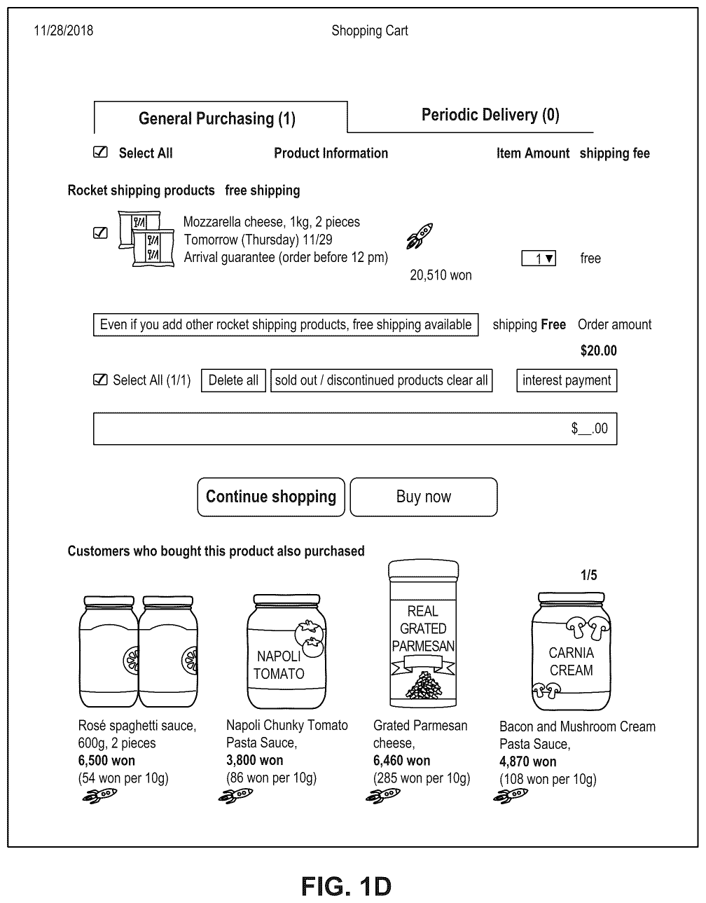

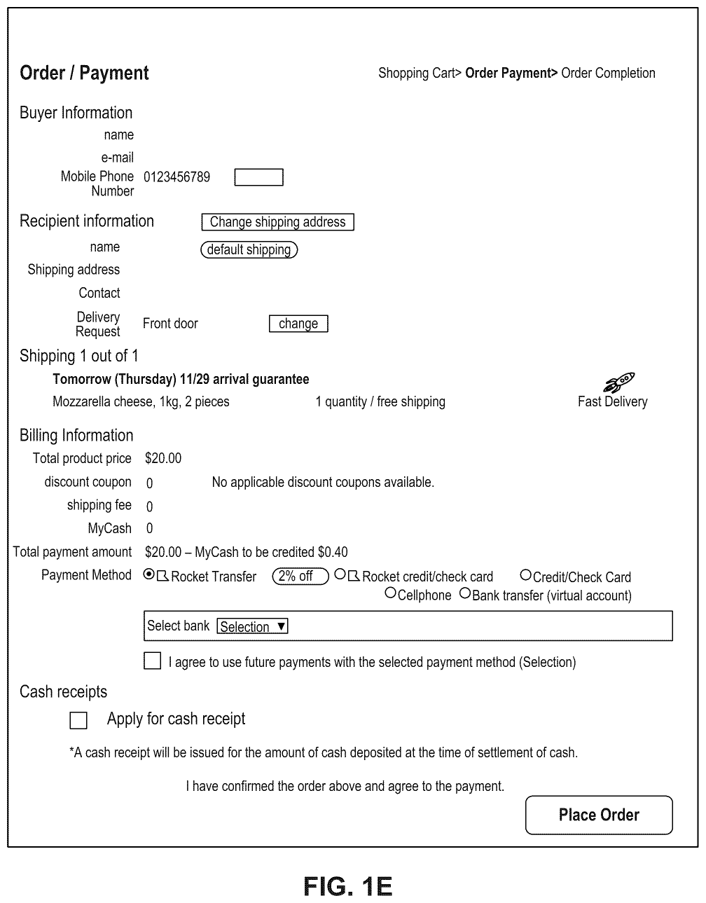

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

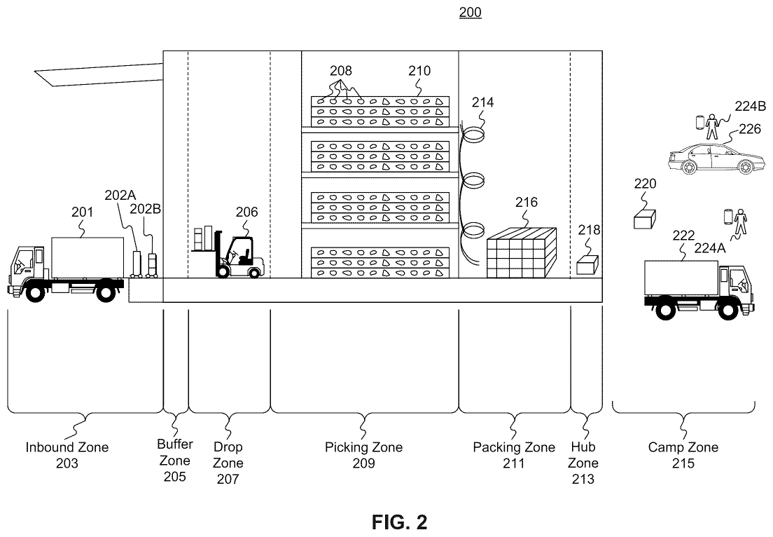

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

According to an aspect of the present disclosure, a computer-implemented system for optimizing product recommendations using a combination of a Random Forest machine learning algorithm and Locality Sensitive Hashing algorithm (LSH) may comprise one or more memory devices storing instructions, and one or more processors configured to execute the instructions to perform operations. A list mapping one or more product identifiers to one or more target customer identifiers may be generated by determining the most optimal attributes of attribute data by running the Random Forest algorithm, and calculating at least one similarity score between customer identifiers by applying the Locality Sensitive Hashing algorithm. In some embodiments, the disclosed functionality and systems may be implemented as part of internal front end system 105 (FIG. 1A). The preferred embodiment comprises implementing the disclosed functionality and systems on internal front end system 105, but one of ordinary skill will understand that other implementations are possible.

The list mapping one or more products (e.g., product identifiers associated with a set of predetermined products) to one or more target customers (e.g., customer identifiers associated with customers most likely to purchase the one or more products due to similarity with other customers who have purchased) can be generated by considering one or more attributes associated with customers interacting with one or more systems in system 100 as discussed above with respect to FIG. 1A. For example, attribute categories may include, but are not limited to, demographics, purchase behaviors, search behaviors, platform usage behaviors, browsing behaviors, or marketing responses.

Demographics may include attributes such as gender, age, operating system used (e.g., iOS, android), membership status (e.g., enrolled in free trial of expedited shipping membership, paid membership, withdrawn/former member/lapsed, etc.), membership usage (e.g., number of orders that used free shipping, same-day delivery, free returns, etc.) last-login date and time, subscription status for notifications, etc. Purchase behaviors may include attributes such as products purchased, purchases by category, a number of purchases by category made over a certain time period (e.g., a quantity of purchases of a product associated with a certain category), ratings by category (e.g., a review rating associated with a product of a certain category), etc. Search behaviors may include attributes such as product searches, searches by category (i.e., a search action associated with a product of a certain product category), a number of searches performed in a certain time period (e.g., an hour, day, week, etc.), etc. Platform usage behaviors may include attributes such as coupon downloaded by category (i.e., downloading a coupon associated with a product of a certain category), search result page by category (e.g., viewed SRP for a certain category), add-to-cart by category (i.e., adding a product of a certain category to online cart), direct buy by category (i.e., purchasing a product of a certain category without adding to cart), etc. Browsing behaviors may include attributes such as likes by category (i.e., marking a “like” user interface element associated with a product of a certain category), a frequent browsing time (e.g., morning, afternoon, evening, weekday, weekend, anytime, etc.), number of browsing days in a certain period of time (e.g., a day, week, month, year), etc. Marketing responses may include attributes such as marketing notifications received by category (i.e., receiving a marketing app push notification/text/email associated with a product of a certain category), marketing notification responses by category (i.e., clicking a marketing app push notification/link associated with a product of a certain category), etc.

Product categories may include accessories, apparel, baby convenience, baby core, baby necessities, beauty, beverages, books, car accessories, chilled frozen, computer digital, domestic travel, electronics, fresh food, home, household, kitchen, healthy meal, overseas travel, personal care, pet, shoes, snacks, sporting goods, stationary, toys, and others.

In order to reduce processing time and conserve resources, a subset of the attributes may be selected by using the Random Forest tree-based algorithm to calculate an impurity value (e.g., Gini Index) for each attribute, and low impurity values may identify the attributes that are relatively better at classifying seed customers (i.e., customers who have purchased a particular product) and non-seed customers. Once the subset of attributes are determined, at least one similarity score may be calculated for customer identifier pairs to determine which customers have the most similar attributes to customers who have previously purchased a product. Based on the at least one calculated similarity score and a set of predetermined rules, the final list of product identifiers mapped to customer identifiers may be generated.

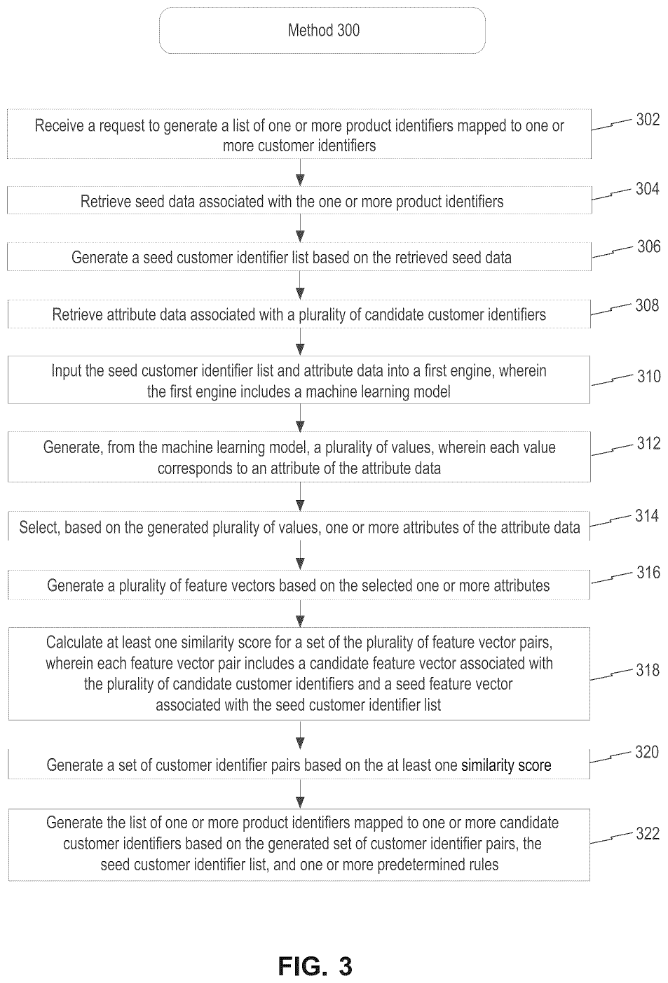

FIG. 3 shows an exemplary method 300 for optimizing product recommendations using a combination of algorithms on internal front end system 105. The method or a portion thereof may be performed by internal front end system 105; in some embodiments, the method or a portion thereof may be performed by another device or system. For example, the system may include one or more processors and one or more memory devices storing instructions that, when executed by the one or more processors, cause the system to perform the steps shown in FIG. 3.

In step 302, one or more processors may be configured to receive a request to generate a list of one or more product identifiers mapped to one or more customer identifiers. As discussed above, internal front end system 105 may be implemented as a computer system that enables internal users (e.g., employees of an organization that owns, operates, or leases system 100) to interact with one or more systems in system 100 as discussed above with respect to FIG. 1A. For example, external front end system 105 may receive a user input (e.g., from a button, keyboard, mouse, pen, touchscreen, or other pointing device) from a user device requesting generating a list of one or more product identifiers mapped to one or more customer identifiers based on data stored in a database (not pictured).

Internal front end system 105, as discussed above with respect to FIG. 1A, may include one or more of a web caching system, a database, a search system, a payment system, an analytics system, an order monitoring system, or the like and store data points associated with customers and products in the database. In some embodiments, the request may originate from internal front end system 105 and be transmitted to a remote computer system to receive information related to optimizing product recommendations. Additionally or alternatively, the request or input may include selection of an element (e.g., button, box, icon) on a graphical user interface of a computer system, such as internal front end system 105, or communicating a request from a first computer system (e.g., a user device) to a second computer system (e.g., internal front end system 105). In some embodiments, one or more processors may be configured to generate a list of one or more product identifiers mapped to one or more customer identifiers periodically (e.g., every day, week, month, predetermined number of days, etc.). In some embodiments, one or more processors may be configured to randomly generate a list of one or more product identifiers mapped to one or more customer identifiers. For example, one or more processors may be configured to randomly generate the list in response to detecting a triggering action (e.g., receiving an alert, detecting a problem, etc.).

In some embodiments, the one or more product identifiers may be associated with a particular set of products. For example, the one or more product identifiers may correspond to a particular set of selected products (e.g., products of one or more specific product categories, products reaching expiration date, products going out of season, limited products, etc.). In some embodiments, the particular set of selected products may be manually selected by one or more users. In some embodiments, one or more processors may be configured to automatically select the particular set of selected products based on product information (e.g., historical, trending, predictive) stored in a database. In some embodiments, the one or more product identifiers may include all product identifiers associated with products available on one or more systems in system 100 as discussed above with respect to FIG. 1A.

In step 304, one or more processors may be configured to retrieve seed data associated with the one or more product identifiers. For example, in response to receiving the request, the one or more processors may be configured to retrieve seed data from a database. In some embodiments, the seed data may include sales data and search data associated with the one or more product identifiers. In some embodiments, the sales data and the search data may comprise one or more seed customer identifiers associated with the one or more product identifiers. In some embodiments, the sales data may include historical purchase data associated with the one or more product identifiers. In some embodiments, the historical purchase data may include one or more seed customer identifiers associated with product purchase actions corresponding to the one or more product identifiers. Additionally or alternatively, the search data may include at least one of tracked search or browsing data associated with the one or more product identifiers. In some embodiments, the tracked search or browsing data may include one or more seed customer identifiers associated with product searching or browsing actions corresponding to the one or more product identifiers. In some embodiments, the retrieved seed data may be data stored over a predetermined period of time. Additionally or alternatively, seed data may include attribute data associated with each seed customer identifier of the one or more seed customer identifiers.

In step 306, one or more processors may be configured to generate a seed customer identifier list based on the retrieved seed data. For example, the retrieved seed data may be input into a seed engine configured to organize the retrieved seed data into a list of one or more customer identifiers along with a seed flag associated with each customer identifier, wherein the seed flag is either a value of 0 indicating not seed or 1 indicating seed. In some embodiments, the one or more processors may be further configured to filter the generated seed customer identifier list based on one or more required attributes. For example, the one or more processors may filter out from the generated seed customer identifier list any customer identifiers not associated with a particular attribute, such as any of those discussed above (e.g., loyalty member, enrolled in push notification, etc.), such that the remaining customer identifiers of the generated seed customer identifier list are associated with the particular attribute.

In step 308, one or more processors may be configured to retrieve attribute data associated with a plurality of candidate customer identifiers. For example, attribute data, such as those discussed above, including demographics, purchase behaviors, search behaviors, platform usage behaviors, browsing behaviors, and marketing responses, may be stored in a database (not pictured) communicatively coupled to one or more processors. In some embodiments, one or more processors may be configured to track and store user action history data (e.g., log tracking data associated with user search behaviors, browsing behaviors, platform usage behaviors, platform usage behaviors, marketing responses, etc.) associated with users accessing services, such as those available on one or more systems in system 100 as discussed above with respect to FIG. 1A. Each user action may be stored as a transaction in user action history data, wherein each transaction may comprise a customer ID, product ID, timestamp, and/or action type ID (e.g., click, add-to-cart, purchase, search, etc.).

In some embodiments, the plurality of candidate customer identifiers may be associated with a particular set of customers. For example, the plurality of candidate customer identifiers may correspond to a particular set of customers associated with a particular attribute, such as any of those discussed above (e.g., loyalty member, frequent buyer, frequent browser, etc.). In some embodiments, the plurality of candidate customer identifiers may include all customer identifiers associated with users who have accessed services available on one or more systems in system 100 as discussed above with respect to FIG. 1A.

In step 310, one or more processors may be configured to input the seed customer identifier list and attribute data into a first engine. For example, the first engine may include a machine learning model and a hashing algorithm. In some embodiments, the machine learning model may comprise a supervised machine learning algorithm, such as random forest, configured to reduce the attribute data to one or more attributes. In some embodiments, the machine learning model may be configured to reduce the attribute data to one or more attributes by constructing a multitude of decision trees, wherein each decision tree corresponds to an attribute of the attribute data. Each decision tree may determine a number of customers associated with a particular attribute (e.g., gender attribute including female class and male class) that did and did not purchase a particular product.

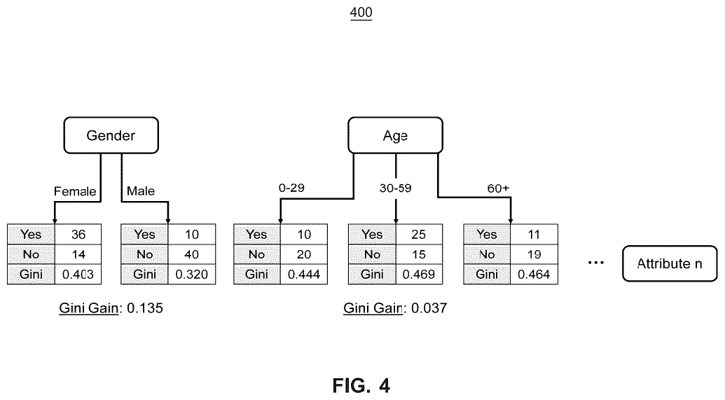

In step 312, the machine learning model may be configured to generate a plurality of values, wherein each value corresponds to an attribute of the attribute data. An exemplary diagram is depicted in FIG. 4, described below. For example, each value of the plurality of values may comprise an impurity score (e.g., Gini Impurity) calculated by running the random forest machine learning algorithm, wherein each impurity score ranges from 0-0.5. For example, in a particular dataset with 50 males and 50 females, 10 out of the 50 males and 36 out of the 50 females may have purchased a particular product. In some embodiments, an impurity score may be calculated for the particular dataset using the following equation:

$$G = ( p ( 1 ) * ( 1 - p ( 1 ) ) + p ( 2 ) * ( 1 - p ( 2 ) ) , wherein$$

$$G = impurity score ( i . e . , Gini Impurity )$$

$$p ( 1 ) = probability of product purchasers$$

$$p ( 2 ) = probability of non ‐ purchasers$$

For example, an impurity score for the particular dataset with 100 people wherein 46 out of 100 have purchased the particular product may be calculated as follows:

$${G}_{dataset} = ( ( \frac{46}{100} ) \times ( 1 - \frac{46}{100} ) ) + ( ( \frac{54}{100} ) \times ( 1 - \frac{54}{100} ) ) = 0.497$$

In some embodiments, an impurity score may be calculated for each attribute using the same equation above. For example, the attribute impurity score may be determined based on an impurity score calculated for each attribute class, which for the gender attribute may be calculated as follows:

$${G}_{male} \int = ( ( \frac{10}{50} ) \times ( 1 - \frac{10}{50} ) ) + ( ( \frac{40}{50} ) \times ( 1 - \frac{40}{50} ) ) = 0 \text{.32}$$

$${G}_{f emale =} \int ( ( \frac{36}{50} ) \times ( 1 - \frac{36}{50} ) ) + ( ( \frac{14}{50} ) \times ( 1 - \frac{14}{50} ) ) = 0.403$$

Once the impurity scores for each attribute class are calculated, the attribute class impurity scores may be weighed based on how many elements each class has in order to determine a Gini Gain value for each attribute. For example, the Gini Gain value may be calculated using the following equation:

$$Gini Gain = {G}_{dataset} - ( ( ( {G}_{class \_ 1} \times ( \frac{\# of elements in attribute class}{\# of elements in dataset} ) ) + ( {G}_{class \_ 2} \times ( \frac{\# of elements in attribute class}{\# of elements in dataset} ) ) + … ( {G}_{class \_ n} \times ( \frac{\# of elements in attribute class}{\# of elements in dataset} ) ) )$$

$$( \# of elements = a number of people in the dataset associated with the attribute )$$

For example, the Gini Gain value for the gender attribute may be calculated as follows:

$$Gini {Gain}_{gender} = 0.497 - ( ( 0.32 \times ( \frac{50}{100} ) ) + ( 0.403 \times ( \frac{50}{100} ) ) ) = 0.362$$

In some embodiments, a higher Gini Gain value (i.e., close or equal to 0.5) may indicate that the attribute is a more decisive factor for differentiating product purchasers from non-purchasers. On the other hand, a lower Gini Gain value (i.e., close or equal to 0) may indicate that the attribute is less relevant for differentiating product purchasers from non-purchasers. For example, in a particular dataset with 50 males and 50 females, 25 out of the 50 males and 25 out of the 50 females may have purchased a particular product. With an equal number of product purchasers and non-purchasers, the gender attribute for this particular product may not be an optimal attribute for differentiating product purchasers from non-purchasers, which would also be reflected by the Gini Gain value of 0.

In step 314, one or more processors may be configured to select, based on the generated plurality of values, one or more attributes of the attribute data. For example, the machine learning model may output a list of attributes ranked from highest Gini Gain value to lowest Gini Gain value. In some embodiments, the machine learning model may not include attributes with Gini Gain values below a predetermined threshold in the outputted list of attributes. In some embodiments, the machine learning model may select a predetermined number (e.g., 1, 10, 30, 100, etc.) of attributes with the highest Gini Gain value. Reducing the attribute data, comprising hundreds of attributes, to one or more attributes with the highest Gini Gain values may increase computational efficiency as well as an accuracy associated with optimizing product recommendations by considering the most relevant attributes (i.e., best attributes for splitting purchasers from non-purchasers).

In step 316, one or more processors may be configured to generate a plurality of feature vectors based on the selected one or more attributes. For example, the first engine may generate a feature vector for each candidate customer identifier of the plurality of customer identifiers and each seed customer identifier of the seed customer identifier list. In some embodiments, each feature vector may be a numerical representation of a customer identifier generated based on the selected one or more attributes of the attribute data.

Once the feature vectors are generated, the first engine may apply the hashing algorithm, such as a locality sensitive hashing algorithm, to each seed feature vector corresponding to the seed customer identifier list to return a set of candidate feature vectors corresponding to the plurality of customer identifiers. For example, the locality sensitive hashing algorithm may assign the same hash value to very similar feature vectors, and thus may be used to determine approximate nearest neighbors by returning one or more candidate feature vectors associated with the plurality of customer identifiers that have been assigned the same hash value as the hash value of each seed feature vector associated with the seed customer identifier list.

In step 318, one or more processors may be configured to calculate at least one similarity score for a set of the plurality of feature vector pairs, wherein each feature vector pair includes a candidate feature vector associated with the plurality of customer identifiers and a seed feature vector associated with the seed customer identifier list. For example, based on the returned set of candidate feature vectors, the first engine may pair each seed feature vector associated with the seed customer identifier list with each candidate feature vector that has been assigned the same hash value and determine a similarity score for each pair. In some embodiments, the similarity score may be a measured distance (e.g., Euclidean, cosine, Chi square, Minkowsky) between a seed feature vector associated with the seed customer identifier list and a candidate feature vector associated with the plurality of customer identifiers. In some embodiments, a lower similarity score (i.e., smaller measured distance) may indicate a higher level of similarity between feature vector pairs

In step 320, one or more processors may be configured to generate a set of customer identifier pairs based on the at least one similarity score. For example, the first engine may remove any feature vector pairs with a similarity score (i.e., distance) above a predetermined threshold. In some embodiments, the first engine may rank each feature vector pair based on the at least one calculated similarity score and/or select one or more feature vector pairs with a similarity score below a predetermined threshold. Based on the selected one or more feature vector pairs, the first engine may generate the set of customer identifier pairs, wherein each customer identifier pair may correspond to a feature vector pair of the selected one or more feature vector pairs. For example, as discussed in step 316, each feature vector may correspond to a candidate customer identifier of the plurality of customer identifiers or a seed customer identifier of the seed customer identifier list.

In some embodiments, steps 306 to 320 may be repeated for each category associated with the one or more product identifiers. For example, the request received in step 302 to generate a list of one or more product identifiers mapped to one or more customer identifiers may include one or more product identifiers, each associated with a product category, such as those discussed above. In some embodiments, all of the one or more product identifiers may be associated with the same product category. In some embodiments, a first set of one or more product identifiers may be associated with a first product category, and a second set of the one or more product identifiers may be associated with a second product category, wherein the first product category and the second product category are different.

Based on the product categories associated with the one or more product identifiers, steps 304-320 may be repeated for each product category such that the one or more processors generates a list of one or more product identifiers mapped to one or more candidate customer identifiers for each product category associated with the one or more product identifiers. For example, in some embodiments, the one or more processors may be configured to receive a request to generate a first list of one or more first product identifiers mapped to one or more first customer identifiers and a second list of one or more second product identifiers mapped to one or more second customer identifiers, wherein the one or more first product identifiers are associated with a first product category and the one or more second product identifiers are associated with a second product category. Based on performing steps 306 to 320 for each product category, the one or more processors may be configured to generate the first list of one or more first product identifiers mapped to one or more first candidate customer identifiers and the second list of one or more second product identifiers mapped to one or more second candidate customer identifiers.

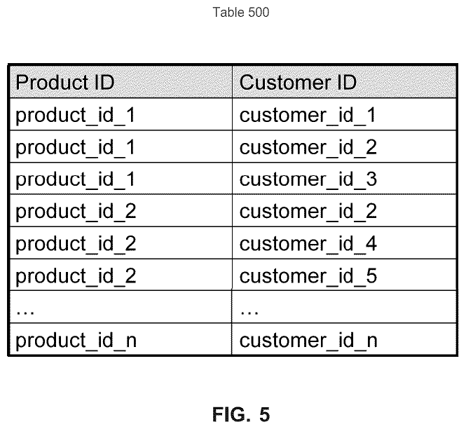

In step 322, one or more processors may be configured to generate the list of one or more product identifiers mapped to one or more candidate customer identifiers based on the generated set of customer identifier pairs, the seed customer identifier list, and one or more predetermined rules. One such list is depicted in FIG. 5, described below. For example, a second engine may generate the list of one or more product identifiers mapped to one or more customer identifiers by receiving the generated set of customer identifier pairs, the seed customer identifier list, and one or more predetermined rules as inputs. In some embodiments, the one or more predetermined rules may include one or more customer related requirements that are specified in the received request to generate the list of one or more product identifiers mapped to one or more customer identifiers. For example, the request may include instructions to remove customer identifiers that are not registered under one or more specific programs (e.g., subscription program, loyalty program, etc.). In some embodiments, the second engine may be configured to remove one or more candidate customer identifiers from the generated set of customer identifier pairs according to the one or more predetermined rules. Additionally or alternatively, the second engine may be configured to map each remaining candidate customer identifier of the generated set of customer identifier pairs to at least one product identifier of the one or more product identifiers based on the paired seed customer identifier of the seed customer identifier list. For example, as discussed in step 304, each product identifier of the one or more product identifiers may be associated with one or more seed customer identifiers, and thus, the second engine may map each candidate customer identifier paired with the one or more seed customer identifiers to the product identifier.

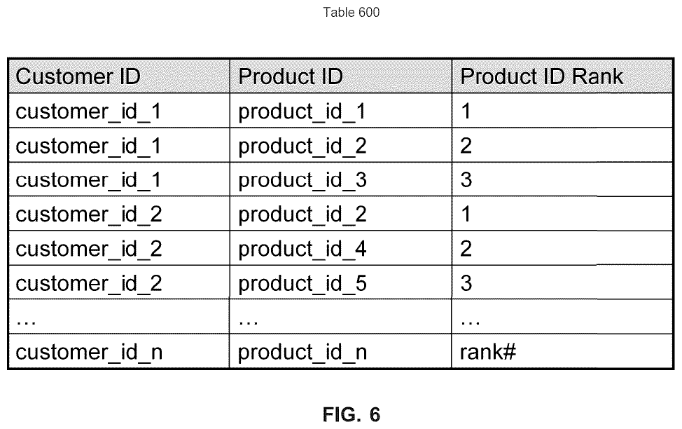

In some embodiments, one or more processors may be configured to map each customer identifier to a predetermined number of product identifiers based on the results of step 318. One such mapping table is depicted in FIG. 6, described below.

In some embodiments, one or more processors may be configured to transmit the generated list of one or more product identifiers mapped to one or more candidate customer identifiers to the user device. For example, the user device may be associated with a management entity. In some embodiments, transmitting the generated list may cause an automated action. For example, in response to receiving the generated list, one or more processors may be configured to cause a customer interface of a customer device associated with a candidate customer identifier of the generated list to display information associated with at least one product identifier of the one or more product identifiers on the generated list. Additionally or alternatively, one or more processors may be configured to retrieve the generated list of one or more product identifiers mapped to one or more candidate customer identifiers and generate one or more webpages associated with the one or more candidate customer identifiers of the generated list, wherein the components of each webpage are uniquely generated based on the associated candidate customer identifier. Additionally or alternatively, one or more processors may be configured to transmit one or more messages to one or more customer devices associated with the one or more candidate customer identifiers of the generated list of the generated list. For example, each message may comprise a text message, a pop-up alert, a mobile push alert, or an email containing information associated with at least one product identifier of the one or more product identifiers of the generated list. Additionally or alternatively, one or more processors may be configured to cause a customer interface of a customer device associated with a candidate customer identifier of the generated list to display one or more advertisements associated with at least one product identifier of the one or more product identifiers of the generated list.

FIG. 4 shows an exemplary diagram 400 illustrating an exemplary process performed by the machine learning algorithm. Each attribute of the attribute data (e.g., gender, age, etc.) branches off into two or more attribute classes. For example, for gender, there is a female gender class and a male gender class. As another example, for age, there is an age range of 0-29, 30-49, and 60+. For some attributes, the attributes branch off into attribute classes of “yes” and “no” (e.g., coupon downloaded attribute, which is an attribute assigned to customer identifiers associated with downloading a coupon for a particular product), wherein the “yes” branch may be associated with customer identifiers that have been assigned the attribute, and the “no” branch may be associated with customer identifiers that have not been assigned the attribute. For each attribute class, the one or more processors determines whether a customer associated with the particular attribute class purchased a particular product. For example, diagram 400 illustrates how many of a dataset of 100 people including 50 females and 50 males, of which 30 were 0-29 years old, 40 were 30-59 years old, and 30 were 60+ years old, purchased or did not purchase a particular product. Diagram 400 shows that, out of 50 females, 36 purchased the product, and out of 50 males, 10 purchased the product. Diagram 400 also shows that of those who are 0-29 years old, 10 purchased the product, of those who are 30-59, 25 purchased the product, and of those who are 60+, 11 purchased the product. A Gini impurity is calculated for the dataset and for each attribute class, and a Gini Gain value is determined for each attribute based on a weighted average of the attribute class impurity scores, as discussed in step 312 of method 300 above. For example, for gender, the Gini Gain value is calculated to be 0.135 and, for age, the Gini Gain value is calculated to be 0.037. Based on the calculated Gini Gain values for gender and age, gender may be selected as an attribute over age because the gender attribute has a higher Gini Gain value. This process is performed for all n attributes of attribute data to determine which attributes have the highest Gini Gain values.

FIG. 5 shows an exemplary table 500 with respect to the list of one or more product identifiers mapped to one or more candidate customer identifiers based on the generated set of customer identifier pairs, the seed customer identifier list, and one or more predetermined rules discussed above. For example, table 500 is an example of a list generated by the one or more processors discussed in step 322 of FIG. 3, wherein product IDs (e.g., product_id_1, product_id_2, . . . product_id_n) are mapped to one or more target customer IDs (e.g., customer_id_1, customer_id_2, customer_id_3, customer_id_4, customer_id_5, . . . customer_id_n).

FIG. 6 shows an exemplary table 600 with respect to a list of one or more customer identifiers mapped to one or more product identifiers. For example, table 600 is an example of a list generated by the one or more processors mapping customer IDs (e.g., customer_id_1, customer_id_2, . . . customer_id_n) to recommended product IDs (e.g., product_id_1, product_id_2, product_id_3, product_id_4, product_id_5, . . . product_id_n) along with a rank (e.g., 1-3) for each product ID. Based on steps 310-318 described in method 300 above, the one or more processors may determine, for each customer ID, a propensity score for each product ID. For example, a propensity score of a product ID for a particular customer ID may be determined by calculating a number of seed customer IDs similar to the particular customer ID out of the total number of seed customer IDs. After determining, for the particular customer ID, the propensity scores for each product ID, the one or more processors may sort the product IDs in descending propensity score order to determine a recommendation rank and may generate a mapping table such as table 600 including some or all of the ranked product IDs.

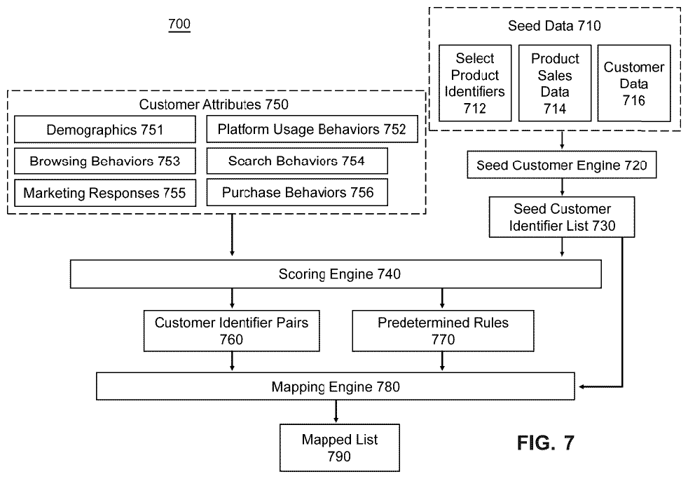

FIG. 7 shows a diagram 700 illustrating an exemplary flow of the steps described in method 300 above. For example, one or more processors may input seed data 710, including select product identifiers 712, product sales data 714, and customer data 716, into seed customer engine 720. Seed customer engine 720 may output seed customer identifier list 730, which may be input into scoring engine 740 (i.e., first engine discussed in FIG. 3) along with customer attributes 750 which include demographics 751, platform usage behaviors 752, browsing behaviors 753, search behaviors 754, marketing responses 755, and purchase behaviors 756. Scoring engine 740 may output customer identifier pairs 760 which are input, along with predetermined rules 770 and seed customer identifier list 730, into mapping engine 780 (i.e., second engine discussed in FIG. 3). Mapping engine 780 may output mapped list 790.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for optimizing product recommendations, the system comprising:
one or more memory devices storing instructions; and
one or more processors configured to execute the instructions to perform operations comprising:
receiving a request to generate a list of one or more product identifiers mapped to one or more candidate customer identifiers;
retrieving seed data associated with the one or more product identifiers;
generating a seed customer identifier list based on the retrieved seed data;
retrieving attribute data associated with a plurality of candidate customer identifiers;
inputting the seed customer identifier list and attribute data into a first engine, wherein the first engine includes a machine learning model;
generating, from the machine learning model, a plurality of values, wherein each value corresponds to an attribute of the attribute data;
selecting, based on the generated plurality of values, one or more attributes of the attribute data;
generating a plurality of feature vectors based on the selected one or more attributes;
calculating at least one similarity score for a set of the plurality of feature vector pairs, wherein each feature vector pair includes a candidate feature vector associated with the plurality of candidate customer identifiers and a seed feature vector associated with the seed customer identifier list;
generating a set of customer identifier pairs based on the at least one similarity score; and
generating the list of one or more product identifiers mapped to one or more candidate customer identifiers based on the generated set of customer identifier pairs, the seed customer identifier list, and one or more predetermined rules.

2. The computer-implemented system of claim 1, wherein seed data includes sales data and search data associated with the one or more product identifiers, and wherein the search data includes at least one of tracked search or browsing data associated with the one or more product identifiers.

3. The computer-implemented system of claim 1, wherein attribute data includes at least one of demographics, purchase behaviors, search behaviors, platform usage behaviors, browsing behaviors, or marketing responses.

4. The computer-implemented system of claim 1, wherein the generated seed customer identifier list associates each product identifier of the one or more product identifiers with one or more seed customer identifiers.

5. The computer-implemented system of claim 1, wherein each value of the plurality of values comprises an impurity score calculated by a random forest machine learning algorithm.

6. The computer-implemented system of claim 1, wherein the one or more processors are further configured to execute the instructions to perform operations comprising:
applying a locality hashing algorithm to each feature vector to determine at least one approximate nearest neighbor feature vector.

7. The computer-implemented system of claim 1, wherein generating the set of customer identifier pairs comprises:
ranking each feature vector pair based on the at least one similarity score; and
selecting one or more feature vector pairs with a similarity score below a predetermined threshold.

8. The computer-implemented system of claim 1, wherein generating the list of one or more product identifiers mapped to one or more candidate customer identifiers comprises inputting the generated set of customer identifier pairs, the seed customer identifier list, and one or more predetermined rules into a second engine.

9. The computer-implemented system of claim 8, wherein the second engine is configured to:
remove one or more candidate customer identifiers from the generated set of customer identifier pairs according to the one or more predetermined rules; and
map each remaining candidate customer identifier of the generated set of customer identifier pairs to at least one product identifier of the one or more product identifiers based on the paired seed customer identifier of the seed customer identifier list.

10. The computer-implemented system of claim 1, wherein the one or more processors are further configured to execute the instructions to perform operations comprising:
transmitting the generated list of one or more product identifiers mapped to one or more candidate customer identifiers to a user device; and
causing a customer interface of a customer device associated with a candidate customer identifier of the generated list of one or more product identifiers mapped to one or more candidate customer identifiers to display information associated with at least one product identifier of the one or more product identifiers.

11. A computer-implemented method for optimizing product recommendations, the method comprising:
receiving a request to generate a list of one or more product identifiers mapped to one or more candidate customer identifiers;
retrieving seed data associated with the one or more product identifiers;
generating a seed customer identifier list based on the retrieved seed data;
retrieving attribute data associated with a plurality of candidate customer identifiers;
inputting the seed customer identifier list and attribute data into a first engine, wherein the first engine includes a machine learning model;
generating, from the machine learning model, a plurality of values, wherein each value corresponds to an attribute of the attribute data;
selecting, based on the generated plurality of values, one or more attributes of the attribute data;
generating a plurality of feature vectors based on the selected one or more attributes;
calculating at least one similarity score for a set of the plurality of feature vector pairs, wherein each feature vector pair includes a candidate feature vector associated with the plurality of candidate customer identifiers and a seed feature vector associated with the seed customer identifier list;
generating a set of customer identifier pairs based on the at least one similarity score; and
generating the list of one or more product identifiers mapped to one or more candidate customer identifiers based on the generated set of customer identifier pairs, the seed customer identifier list, and one or more predetermined rules.

12. The computer-implemented method of claim 1, wherein seed data includes sales data and search data associated with the one or more product identifiers, and wherein the search data includes at least one of tracked search or browsing data associated with the one or more product identifiers.

13. The computer-implemented method of claim 1, wherein attribute data includes at least one of demographics, purchase behaviors, search behaviors, platform usage behaviors, browsing behaviors, or marketing responses.

14. The computer-implemented method of claim 1, wherein the generated seed customer identifier list associates each product identifier of the one or more product identifiers with one or more seed customer identifiers.

15. The computer-implemented method of claim 1, wherein each value of the plurality of values comprises an impurity score calculated by a random forest machine learning algorithm.

16. The computer-implemented method of claim 1, the method further comprising:
applying a locality hashing algorithm to each feature vector to determine at least one approximate nearest neighbor feature vector.

17. The computer-implemented system of claim 1, wherein generating the set of customer identifier pairs comprises:
ranking each feature vector pair based on the calculated at least one similarity score; and
selecting one or more feature vector pairs with a similarity score below a predetermined threshold.

18. The computer-implemented system of claim 1,
wherein generating the list of one or more product identifiers mapped to one or more candidate customer identifiers comprises inputting the generated set of customer identifier pairs, the seed customer identifier list, and one or more predetermined rules into a second engine, and
wherein the second engine is configured to:
remove one or more candidate customer identifiers from the generated set of customer identifier pairs according to the one or more predetermined rules; and
map each remaining candidate customer identifier of the generated set of customer identifier pairs to at least one product identifier of the one or more product identifiers based on the paired seed customer identifier of the seed customer identifier list.

19. The computer-implemented system of claim 1, wherein the method further comprises:
transmitting the generated list of one or more product identifiers mapped to one or more candidate customer identifiers to a user device; and
causing a customer interface of a customer device associated with a candidate customer identifier of the generated list of one or more product identifiers mapped to one or more candidate customer identifiers to display information associated with at least one product identifier of the one or more product identifiers.

20. A computer-implemented system for optimizing product recommendations, the system comprising:
one or more memory devices storing instructions; and
one or more processors configured to execute the instructions to perform operations comprising:
receiving, from a user device, a request to generate a list of a plurality of product identifiers mapped to a plurality of potential customer identifiers;
inputting a seed customer identifier list and attribute data into a first engine, wherein the first engine includes a machine learning algorithm;
generating, using the machine learning algorithm, a plurality of values to select a plurality of attributes of the attribute data;
generating a plurality of feature vectors based on the generated plurality of values;
calculating a plurality of similarity scores, wherein each similarity score corresponds to a feature vector pair of a plurality of feature vector pairs, and wherein each feature vector pair includes a potential feature vector and a seed feature vector;
generating the list of the plurality of product identifiers mapped to the plurality of potential customer identifiers based on the calculated plurality of similarity scores, the seed customer identifier list, and one or more predetermined rules;
transmitting the generated list of the plurality of product identifiers mapped to the plurality of potential customer identifiers to the user device; and
causing a customer interface of a customer device associated with a potential customer identifier of the generated list of the plurality of product identifiers mapped to the plurality of potential customer identifiers to display information associated with at least one product identifier of the plurality of product identifiers.
